(19) United States
(12) Patent Application Publication
(10) Pub. No.: US 2010/0060725 A1
(43) Pub. Date: Mar. 11, 2010

(54) METHOD FOR FAST COMMUNICATION BETWEEN INSIDE AND OUTSIDE OF BODY USING ANALOG ELECTRICAL SIGNAL AND SYSTEM THEREOF

(76) Inventors: Han Jung, Daejeon (KR); Won-Woo Cho, Gyeonggi-Do (KR); Byung-Hyuk Kim, Daejeon (KR); Chul Cha, Daejeon (KR); Sang-Heun Park, Daejeon (KR)

Correspondence Address: OSTROLENK FABER GERB & SOFFEN, 1180 AVENUE OF THE AMERICAS, NEW YORK, NY, 100368403, US

(21) Appl. No.: 12/447,490

(22) PCT Filed: Sep. 7, 2007
(86) PCT No.: PCT/KR2007/004344

§ 371 Date: Apr. 28, 2009

(30) Foreign Application Priority Data
Nov. 16, 2006 (KR) 10-2006-0113524

(51) Int. Cl. H04N 7/18; G08B 23/00; H04N 7/01

(52) U.S. Cl. 348/65; 340/573.1; 348/441; 348/E07.085; 348/E07.003

(57) ABSTRACT

In a method for fast communication between inside and outside of a human or animal body using an analog electrical signal and a system thereof, by using a TV standard signal suitable for an international specification such as NTSC, PAL and the like, as the analog electrical signal, image information on the inside of the human or animal body can be monitored in the form of moving pictures through a general TV without any complicated receiving system. The method for fast communication between the inside and outside of the human or animal body using the analog electrical signal comprises a) conducting, by a transmitter inserted inside the human or animal body, the analog electrical signal with respect to information on the inside of the human or animal body by using a medium of the inside of the human or animal body as a wire (line), b) sensing the analog electrical signal on the surface of the medium from the outside of the human or animal body, and c) outputting the information on the inside of the human or animal body included in the analog electrical signal sensed on the surface of the medium.

### DISCLOSURE OF INVENTION

### Technical Solution

The present invention relates to a method for fast communication between inside and outside of a (human, or animal) body using an analog electrical signal and a system thereof.

A method for fast communication between inside and outside of a body according to the related art, for example, using the body as a medium, transmits, to the outside of the body, various information related to the body collected by sensors installed in the organs inside the body using radio frequency (RF) signals at a frequency region harmless to the body. The related art method converts low-speed data into an RF signal of several to several hundred MHz for transmission. Accordingly, power consumption is increased. Also, a directional problem of an antenna may easily cause a change in receiving sensitivity of the RF signal. In addition, it is difficult to miniaturize the sizes of antenna and RF circuit.

In order to solve such problem of the method for communication between inside and outside of the body using the RF signal, this applicant developed “a method and apparatus for communication between inside and outside of a medium using the medium, such as a body, as a communication line” filed on Korean Patent No. 0536188. Here, an electrical signal inside the medium is transferred to the outside of the medium as a digital signal.

However, since the information is transmitted between the inside and outside of the body by a digital method, a transfer rate is restricted (e.g., 2 to 3 frames per second). Accordingly, when transmitting video (image) information, the information cannot be checked in the form of moving images but should be observed in the form of still images.

Therefore, it is an aspect of the present invention to allow information, particularly, image (video) information on the inside of the human or animal body to be transceived between inside and outside of a human or animal body.

It is another aspect of the present invention to allow information particularly, image information (i.e., moving images, or video) on the inside of a human or animal body to be monitored through a general television without an expensive receiving system by using an international standards, such as NTSC (National Television System Committee), PAL (Phase Alternation Line), etc. Here, encoding an image using any one of the international standards allows the image to be easily reproduced.

To achieve these objects, there is provided a method for fast communication between inside and outside of a human or animal body, comprising: a) conducting, by a transmitter within the human or animal body, an analog electrical signal with respect to information on the inside of the human or animal body through the human or animal body; b) sensing the analog electrical signal on the surface of the outside of the human or animal body; and c) outputting the information on the inside of the human or animal body included in the sensed analog electrical signal.

To achieve these objects, there is also provided a system for fast communication between inside and outside of a human or animal body comprising: a transmitter which is placed within the human or animal body to conduct an analog electrical signal with respect to information on the inside of the human or animal body through the human or animal body; a receiver which senses the analog electrical signal on the surface of the outside of the human or animal body; and an output device which outputs the information on the inside of the human or animal body included in the sensed analog electrical signal.

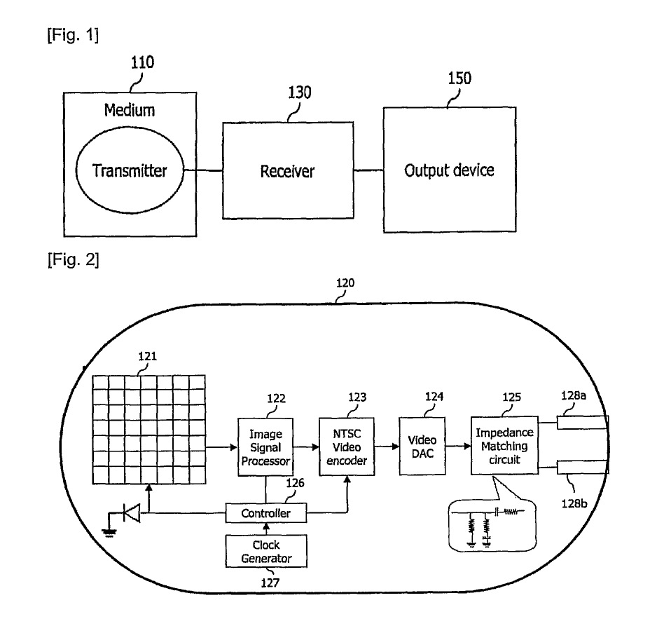

FIG. 1 illustrates an entire construction of a fast communication system in accordance with one embodiment of the present invention;

FIG. 2 illustrates the construction of a transmitter of FIG. 1 in accordance with the one embodiment of the present invention;

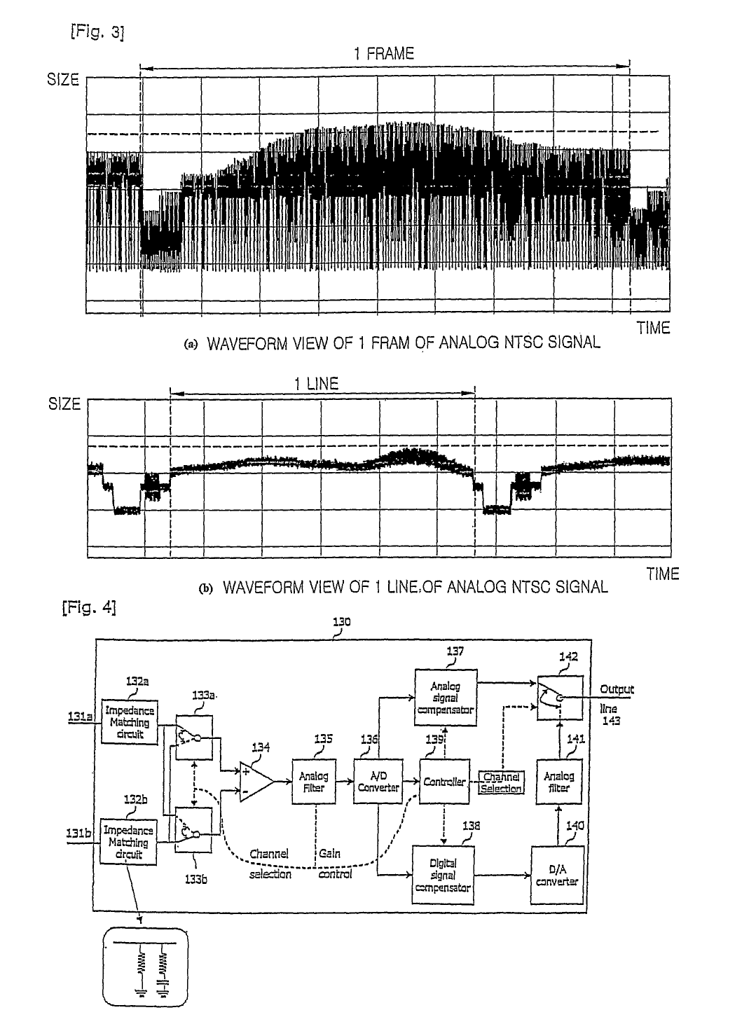

FIG. 3 is an exemplary view of an image (video) signal converted into an analog NTSC signal; and

FIG. 4 illustrates the construction of a receiver of FIG. 1 in accordance with the one embodiment of the present invention.

### MODES FOR CARRYING OUT THE PREFERRED EMBODIMENTS

Hereinafter, reference will now be made in detail to the preferred embodiments of the present invention, examples of which are illustrated in the accompanying drawings. For the sake of explanation, if any detailed description of related functions and constructions make the content (purpose) of the present invention unclear, the detailed description will be omitted.

FIG. 1 illustrates an entire construction of a fast communication system in accordance with one embodiment of the present invention. A fast communication system may comprise a medium 110, a transmitter 120 to conduct an analog electrical signal with respect to information on the inside of the human or animal body through the medium 110, a receiver 130 to sense the conducted analog electrical signal from the surface of the medium 110 and perform a specific processing therefore so as to transfer the processed signal to an output device; and an output device 150 to output the information included in the signal transferred from the receiver 130.

The medium 110 employed in the present invention may be not only a human or animal body but also materials with high impedance such as water, liquid solution containing a specific chemical material therein or the like. Thus, the medium 110 may denote every animal including the human or animal body and every material made of a conductive medium.

The transmitter 120 may be put in the medium 110 to convert the information related to the inside of the human or animal body into an optimum analog electrical signal, thereby transmitting the information to the outside of the human or animal body. According to the embodiment, the transmitter 120 may comprise a unit to directly collect the information on the inside of the human or animal body.

This specification preferably describes an embodiment in which the transmitter 120 collects image information on the inside of the human or animal body and transmits the collected information to the outside of the human or animal body. However, the information on the inside of the human or animal body may include analyzed results of the inside of the human or animal body including various information (e.g., PH, temperature, electric impedance, etc.), image information, sound information and the like. Therefore, in the aspect of the embodiment, the transmitter 120 may be implemented as an apparatus or a system each of which is appropriate to collect the various information. For example, the transmitter 120 may comprise a camera to capture the image (information) related to the inside of the human or animal body.

FIG. 2 illustrates the construction of the transmitter of FIG. 1 in accordance with the one embodiment of the present invention in order to explain an operational principle of the transmitter 120 in more detail.

As illustrated in FIG. 2, the transmitter 120 may comprise a pixel array 121 to capture an image signal and store it, an image signal processor 122 to optimize the obtained image signal, an NTSC video encoder 123 to convert the optimized image signal to be suitable for an NTSC format, a video DAC (Digital to Analog Converter) 124 to convert a digital signal generated by the NTSC video encoder 123 into an analog video signal, a controller 126 to control states of the pixel array 121, the image signal processor 122 and the NTSC video encoder 123, an impedance matching circuit 125 to transfer the analog video signal coming from the NTSC video DAC to two transmitting electrodes, the two transmitting electrodes 128a and 128b to conduct the analog electrical signal with respect to image information through the medium 110 (i.e., the human or animal body), and a clock generator 127 to determine an operational frequency. Also, the transmitter 120 may further include a lighting device to adjust contrast of an image.

Here, the image signal processor 122 may perform functions, such as auto gain control, color correction, gamma correction, edge enhancement and the like, thus to optimize the image signal (information).

The NTSC video encoder 123 may convert the format of the image signal optimized by the image signal processor 122 into an NTSC format as a standard TV communication method. However, this is merely exemplary. The NTSC video encoder 123 may be a device capable of converting the image information (signal) into a standard image signal in a PAL format other than the NTSC format, and also be any apparatus or system capable of converting the image signal into an appropriate image signal according to embodiments.

The video DAC 124 may convert a digital NTSC signal generated from the NTSC video encoder 123 into an analog NTSC video signal. The converted analog NTSC signal is transmitted to the outside of the human or animal body according to a difference between voltages applied to the two transmitting electrodes 128a and 128b, respectively. Thus, the image information on the inside the human or animal body may be transmitted to the outside of the human or animal body as the analog electrical signal other than the digital signal. As such, since the image information is transmitted as the analog signal, the image can be transmitted at a speed of 30 frames per second (30 frame/s), for example. FIG. 3 exemplarily illustrates a waveform of 1 frame of the analog NTSC signal and a waveform of 1 line of the analog NTSC signal.

For example, it is assumed that the range of a size A which the analog NTSC video signal can have is A1≦A≦A2, and the range of a difference V between voltages which may be respectively applied to the two transmitting electrodes 128a and 128b is V1≦V≦V2. Here, in correspondence with the analog video signal A, the difference between the voltages applied to the two transmitting electrodes 128a and 128b, respectively, may be

$$V = \frac{V 2 - V 1}{A 2 - A 1} X ( A - A 1 )$$

. Therefore, the analog NTSC video signal indicating the captured image information is scaled and then can be transmitted to the outside of the human or animal body according to the difference of the amplitudes of the voltages. This is merely exemplary for better understanding.

In the aspect of the embodiment, the analog signal can be conducted as an electrical signal through the medium 110 (i.e., human or animal body) in another method. That is, an original signal is transmitted without being converted. The analog electrical signal can be transmitted by being loaded on a carrier of a frequency having the highest conductivity inside of the human or animal body. In this case, a modulator may be additionally employed in the transmitter 120 to transmit only a signal of a specific frequency, and a demodulator may be additionally employed in the receiver 130 to demodulate the signal of the specific frequency to restore it into an original signal.

The impedance matching circuit 125 allows the analog electrical signal to be matched with an impedance of the medium 110 (i.e., the human or animal body) in order to optimally transfer the analog electrical signal inside the medium 110 (i.e., the human or animal body), and restricts the flow of a current being harmful to the human or animal body. An exemplary impedance matching circuit is illustrated below the component 125. However, it may depend on embodiments, and can be implemented as any circuit or apparatus performing the function mentioned above.

As previously described, FIG. 2 illustrates the embodiment of transmitting the image information as the analog electrical signal in the NTSC format to the outside of the human or animal body. This is merely exemplary. It should be noticed that the transmitter 120 may be any one of a device, a circuit and a system each capable of transmitting every information on the inside of the human or animal body to the outside of the human or animal body using the electrical signal or the analog electrical signal in the PAL format.

Since the voltage difference is applied between the two transmitting electrodes 128a and 128b of the transmitter 120, a current flows between the two transmitting electrodes 128a and 128b through the human or animal body, like a wire (line). Here, the current may also flow on the surface of the outside of the human or animal body. Accordingly, the image information can be transmitted to the outside of the human or animal body by electrical signals flown out of two positions (e.g., two transmitting electrodes) on the surface of the outside of the human or animal body (e.g., skin of the human or animal).

As depicted above, the difference of the electrical signals received at each of the two positions on the surface of the medium 110, namely, at each of the two receiving electrodes is amplified at the receiver 130 of FIG. 1, and passes a filter. The signal distorted while passed through a transmission channel, such as the medium 110 is restored (compensated or corrected) to be transmitted to the output device 150.

FIG. 4 illustrates the construction of a receiver of FIG. 1 in accordance with the one embodiment of the present invention.

The receiver 130 may comprise receiving electrodes 1311 and 131b, impedance matching circuits 132a and 132b, first switching circuit 133a, a second switching circuit 133b, a analog filter 135, a A/D converter 136, a analog signal compensator 137, a digital signal compensator 138, a controller 139, a D/A converter 140, an analog filter 141, and a third switching circuit 142. The first switching circuit 133a and the second switching circuit 133b are connected to the receiving electrodes 131a and 131b, respectively, and have output lines connected to a plug (+) terminal and a minus (−) terminal of the differential amplifier 134, respectively. The differential amplifier 134 to amplify a difference between signals outputted from the first and second switching circuits 133a and 133b respectively connected to the plus (+) terminal and the minus (−) terminal of the differential amplifier 134. The analog filter 135 removes noise of the amplified signal. The A/D converter 136 converts a signal passed through the analog filter 135 into a digital signal and inputs the converted digital signal to the controller 139. The analog signal compensator 137 compensates the signal, which has distortion, passed through the analog filter 135. The digital signal compensator 138 compensates the digital signal, which has distortion, converted by the A/D converter 136. The third switching circuit 142 selects an optimum signal among signals coming from the analog signal compensator 137 and the digital signal compensator 138 and outputs the selected optimum signal to an output line 143. The controller 139 controls the analog signal compensator 137, the digital signal compensator 138 and the first, second and third switching circuits 133a, 133b and 142. Preferably, the receiver 130 may further comprise impedance matching circuits 132a and 132b connected between the corresponding receiving electrodes 131a and 131b and the corresponding first and second switching circuits 133a and 133b, respectively. These components of the receiver 130 are explained in more detail below.

The receiving electrodes 131a and 131b are electrodes to receive currents flowing on the surface of the medium 110. FIG. 3 illustrates the two receiving electrodes for the sake of explanation. However, plural pairs of receiving electrodes may be useable other than the one pair of receiving electrodes. Here, a pair of receiving electrodes having the greatest voltage difference may be selected among the pairs of receiving electrodes to be used for restoring image information on the inside of the human or animal body.

Accordingly, the first and second switching circuits 131a and 131b are provided so as to select a pair of receiving electrodes having the greatest voltage difference therebetween among the plural pairs of receiving electrodes and to input signals from two receiving electrodes 131a and 131b configuring the selected pair of receiving electrodes into the differential amplifier 134. Therefore, the pair of receiving electrodes 131a and 131b having the greatest voltage difference therebetween are selected by the first and second switching circuits 133a and 133b, respectively, as shown in the embodiment of FIG. 4. This selection is performed under the control of the controller 139. For example, the selection may be performed by storing signal differences of the plural pairs of receiving electrodes and comparing one another.

The impedance matching circuits 132a and 132b may be further provided between the corresponding receiving electrodes 131a and 131b and the corresponding first and second switching circuits 133a and 133b, respectively. Here, each of the impedance matching circuits 132a and 132b performs an impedance matching with the medium 110 so as to allow an optimum signal reception within a limited current range. Also, each of the impedance matching circuits 132a and 132b compensates (corrects) conductivity of the human or animal body so as to decrease distortion of an original signal. The impedance matching circuit may be configured by a circuit indicated at the component 132b by an arrow in FIG. 4, which is merely exemplary. It should be understood that any circuit, apparatus or system capable of performing the aforementioned functions can be used as the impedance matching circuit.

The output line of the first switching circuit 133a is connected to the plus (+) terminal of the differential amplifier 134 and the output line of the second switching circuit 133b is connected to the minus (−) terminal of the differential amplifier 134. The differential amplifier 134 amplifies the difference between signals of the selected receiving electrodes 131a and 131b. An electrical signal received at the receiving electrodes 131a and 131b becomes very weak, for example, by being passed through a high resistive medium 110 such as the human or animal body. Accordingly, the differential amplifier 134 is preferably disposed.

A frequency conductivity of the medium 110 such as the human or animal body is nonlinear. That is, the conductivity depends on a frequency. For example, in case of using the human or animal body as the medium, the conductivity according to the frequency may be different for each person or at portions inside the human or animal body. Therefore, such an NTSC signal passed through the medium 110 such as the human or animal body is significantly distorted and thereby becomes a different type of signal from that of the signal transmitted by the transmitter 120. That is, a specific frequency component may be attenuated or amplified, or square wave may be outputted in an impulse form. The distortion of the signal may be worse due to various frequency components of the NTSC signal. Accordingly, the analog signal compensator 137 and the digital signal compensator 138 are required to compensate the signal having a distortion, which occurs while the signal passes through the transmission channel (e.g., the medium 110 such as the human or animal body).

The controller 139 of the receiver 130 has information related to the frequency characteristics of a non-distorted signal (e.g., NTSC signal) (i.e., information obtained after Fourier Transform). Accordingly, the controller 139 analyzes the frequency conductivity of the distorted signal, passed through the transmission channel, to compare it with the frequency characteristics of the non-distorted signal, and thereafter allows the analog signal compensator 137 or the digital signal compensator 138 to perform an appropriate signal processing therefor such that the distorted signal can be compensated. This signal processing may be performed by amplifying or attenuating a specific frequency component. Also, the transfer characteristics is different for the transmission channel (i.e., the medium such as the human or animal body) and according to the frequency. Accordingly, the analog signal compensator 137 or the digital signal compensator 138 preferably includes various signal processing algorithms.

The amplified signal having noise removed therefrom when it passes through the analog filter 135 is inputted into the analog signal compensator 137. The analog signal compensator 137 compensates the signal distorted while passed through the transmission channel with respect to an analog signal. The analog signal compensator 137 may include a plurality of signal processing circuits expected to be required. Therefore, according to the analysis of the distorted analog signal and the non-distorted analog signal, the signal passed through the analog filter 135 may pass through either only one appropriate signal processing circuit or the plurality of signal processing circuits sequentially. As such, as the distorted analog signal passes through the appropriate signal processing circuit within the analog signal compensator 137, it can be compensated to be almost the same to the non-distorted analog signal. Here, the analysis and comparison of the distorted and non-distorted signals and the selection of the appropriate signal processing circuit can all be performed by the controller 139 within the receiver 130.

The digital signal compensator 138 receives a signal outputted from the A/D converter 136 and compensates a signal distorted while passed through the transmission channel with respect to a digital signal. The digital signal compensator 138 is obtained by implementing the analog signal compensator in a digital manner. Compared with the analog signal compensator 137, the digital signal compensator 138 can be freely and easily implemented, and various types of analog signal compensators 138 may exist. Therefore, a signal processing function for compensating the digital signal can be achieved thereby. Since the analog signal compensator 138 already includes the signal processing circuit(s), it is impossible or very difficult to change its configuration later. On the other hand, the digital signal compensator 138 can be changed after being implemented and also can include various signal processing blocks. Thus, it can be flexibly operated according to an analyzed result.

The third switching circuit 142 selects one of outputs of the analog signal compensator 137 and the digital signal compensator 138 and outputs it to the output line 143. Here, the controller 139 compares the signals outputted from the analog signal compensator 137 and the digital signal compensator 138 to the non-distorted signal, so as to allow the third switching circuit 142 to select one signal more similar to the non-distorted signal. Here, the output line 143 is connected to a video input connector of a general TV. Accordingly, in order to select a signal outputted from the digital signal compensator 138 for use, a D/A converter 140 and an analog filter 141 may further be required as illustrated in FIG. 4.

The construction of the receiver 130 illustrated in FIG. 4 is merely exemplary. The receiver 130 may be implemented as any of an apparatus, a circuit or a system each capable of performing the functions of the receiver 130. In accordance with the embodiment, the receiver 130 can be implemented in various manners so as to receive an analog electrical signal flowing on the surface of the medium 110 and then output an appropriate output signal to an input connector of the output device 150 such as a general TV.

The output line 143 of FIG. 4 is connected to the output device 150 of FIG. 1. The output device 150 can be any device or system capable of receiving a signal from the output line 143 to thusly output information related to the inside of the human or animal body.

The transmitter 120 of FIG. 1 transmits information on the inside of the human or animal body (i.e., image information) to the outside of the human or animal body as an analog NTSC electrical signal. Therefore, in this embodiment, the output device 150 may be the general NTSC type TV, and the output line 144 of FIG. 4 may be connected to a video input connector of the TV. Thus, by using an analog NTSC electrical signal as the analog electrical signal, the output line of the receiver 130 can be connected to the video input connector of the general TV without any transceiving system required, thereby allowing the image information on the inside of the human or animal body to be directly monitored in the form of moving pictures. That is, since the information transmission between inside and outside of the human or animal body was not performed using signals suitable for the international specification in the related art, the receiver 130 had to separately include an image processing circuit(s). However, in the aspect of the embodiment, the output of the receiver 130 is connected to the video input connector of the general TV without separate image processing circuits and separate displays, thereby easily restoring images.

This is just exemplary. The output device 150 may be a general PAL type TV as well as by the NTSC type TV. Besides, the output device 150 may be a display which displays the information on the inside of the human or animal body as images, a storage unit which stores the information on the inside of the human or animal body, or a sound output device which outputs the information on the inside of the human or animal body as sound. The output device 150 may also be any apparatus or system capable of outputting the information on the inside of the human or animal body.

In a preferred embodiment, the analog electrical signal used in fast communication between inside and outside of the human or animal body in the present invention may be a baseband analog electrical signal. For example, an analog electrical signal of less than 20 MHz can be used for the medium 110 such as the human or animal body. This is because the signal transmission may be restricted due to noise and interference at a frequency more than that frequency. However, the numeral, which is merely exemplary, should not be construed as limiting the present invention. Depending on embodiments, an analog electrical signal of another frequency band can be used.

As described above, image information can be fast transmitted and received between inside and outside of a human or animal body using an analog electrical signal.

Also, by using a signal in the format of standard signal such as NTSC, PAL, and the like as the analog electrical signal, the image information on the inside of the human or animal body can be monitored in the form of moving pictures through a general TV without any expensive receiving system.

The present invention has been explained with reference to the embodiments which are merely exemplary. It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A method for fast communication between inside and outside of a human or animal body, comprising:
a) conducting, by a transmitter within the human or animal body, an analog electrical signal with respect to information on the inside of the human or animal body through the human or animal body;
b) sensing the analog electrical signal on the surface of the outside of the human or animal body; and
c) outputting the information on the inside of the human or animal body included in the sensed analog electrical signal.

2. The method of claim 1, wherein the information on the inside of the human or animal body is image information on the inside of the human or animal body, wherein in the step c) the image information on the inside of the human or animal body is outputted in the form of moving pictures.

3. The method of claim 1, wherein the analog electrical signal is an analog electrical signal in an NTSC or PAL format,
wherein at the outputting step the image information on the inside of the human or animal body is outputted in the form of the moving pictures through an NTSC or PAL type television.

4. The method of claim 3, wherein the step a) comprises:
encoding the image information on the inside of the human or animal body into a digital signal in an NTSC or PAL format;
converting the digital signal in the NTSC or PAL format into an analog signal in the NTSC or PAL format; and
applying the analog signal in the NTSC or PAL format to two transmitting electrodes according to an electric potential difference.

5. The method of claim 4, wherein the step a) further comprises:
optimizing the image information before the encoding step; and
matching the analog signal in the NTSC or PAL format with an impedance of the medium before the applying step.

6. The method of claim 3, wherein the sensing comprises:
receiving the conducted analog electrical signal at two positions on the surface of the outside of the human or animal body;
amplifying a difference between the received analog electrical signals; and
compensating the amplified analog signal having distortion.

7. The method of claim 6, wherein the sensing further comprises:
converting the amplified analog signal into a digital signal; and
compensating the digital signal having distortion.

8. The method of claim 7, wherein the sensing further comprises:
selecting one of the compensated analog and digital signals,
wherein at the selection step, a less distorted signal of the compensated signals is selected.

9. The method of claim 6, wherein the sensing further comprises:
matching the analog electrical signals in the NTSC format received at the two positions with an impedance of the human or animal body.

10. The method of claim 1, wherein a frequency range of the analog electrical signal is less than 20 MHz.

11. A system for fast communication between inside and outside of a human or animal body comprising:
a transmitter which is placed within the human or animal body to conduct an analog electrical signal with respect to information on the inside of the human or animal body through the human or animal body;
a receiver which senses the analog electrical signal on the surface of the outside of the human or animal body; and
an output device which outputs the information on the inside of the human or animal body included in the sensed analog electrical signal.

12. The system of claim 11, wherein the information on the inside of the human or animal body is image information on the inside of the human or animal body, and the output device is a device capable of outputting the image information in the form of moving pictures.

13. The system of claim 12, wherein the analog electrical signal is an analog electrical signal in an NTSC or PAL format, and the output device is an NTSC or PAL type television.

14. The system of claim 13, wherein the transmitter comprises:
a video encoder which converts the image information into a digital signal in the NTSC or PAL format;
a video DAC (Digital to Analog Converter) which converts the digital signal in the NTSC or PAL format into an analog signal in the NTSC or PAL format; and
two transmitting electrodes to which an electrical potential difference according to the analog signals in the NTSC or PAL format is applied.

15. The system of claim 14, wherein the transmitter further comprises:
an image signal processor which optimizes the image information and outputs the optimized image information to the video encoder; and
an impedance matching circuit which matches the analog signal in the NTSC or PAL format with an impedance of the human or animal body.

16. The system of claim 13, wherein the receiver comprises:
a pair of receiving electrodes which receives the conducted analog electrical signals at two positions on the surface of the outside of the human or animal body;
a differential amplifier which amplifies a difference between the received analog electrical signals in the NTSC format; and
an analog signal compensator which compensates the amplified analog signal having a distortion,
wherein the analog signal compensator comprises at least one signal processing circuit.

17. The system of claim 16, wherein the receiver further comprises:
an A/D converter which converts the amplified analog signal into a digital signal; and
a digital signal compensator which compensates the digital signal having a distortion,
wherein the digital signal compensator comprises at least one signal processing block.

18. The system of claim 17, wherein the receiver further comprises:
a switching circuit which selects one of signals outputted from each of the analog signal compensator and the digital signal compensator; and
a controller which allows the switching circuit to select a less distorted signal from the signals outputted from each of the analog signal compensator and the digital signal compensator.

19. The system of claim 16, wherein the receiver further comprises:
an impedance matching circuit which matches the analog electrical signals in the NTSC format received at two positions with an impedance of the human or animal body.

20. The system of claim 11, wherein a frequency of the analog electrical signal is less than 20 MHz.
